(19) United States
(12) Patent Application Publication
(10) Pub. No.: US 2002/0088256 A1
(43) Pub. Date: Jul. 11, 2002

(54) Combination push button and/or key operated padlock

(75) Inventors: Jewell A. Taylor, Salinas, CA (US); George M. Yulich, Salinas, CA (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Stop Lock, Inc.

(21) Appl. No.: 09/757,854

(22) Filed: Jan. 10, 2001

(51) Int. Cl. E05B 37/18

(52) U.S. Cl. 70/25; 70/284

(57) ABSTRACT

A combination push button and/or key operated padlock is disclosed as having a housing, a shackle detachably connected to the housing for opening and closing the padlock, a push button slide plate for operative detachable movement of the shackle relative to the housing, and a plurality of push buttons mounted to the housing for the push button slide plate. At least one of the push buttons is a releasing push button that detach from the push button slide plate when depressed. The remainder of the push buttons are blocking push buttons that engage the push button slide plate when depressed. A shackle detachment is connected to the push button slide plate for moving it in detachable position when the releasing push buttons only are depressed. Each of the push buttons having independently mounted spring loaded end caps on each free end to assist in camouflaging the releasing and blocking push button from each other. In lieu of opening and closing the padlock with push buttons, a key operated lock may be used for this purpose.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to a combination push button and/or key operated padlock, as compared to key operated only or rotary dial type padlocks, and more particularly, to a combination push button and/or key operated padlock which uniquely, practically, economically and efficiently overcomes the problems associated with corresponding push button and/or key operated padlocks.

Push button padlocks have significant advantages over rotary dial and key type padlocks. These advantages include quick, easy and accurate operation; being relatively pick-resistant as compared to rotary dial locks; capable of being opened in the dark or by physically handicapped persons. Unfortunately, push button padlocks have not gained favor in the market because they have been unnecessarily complex, too costly, and/or not capable of functioning as intended. Some examples of prior art push button padlocks are shown in U.S. Pat. Nos. 4,751,830; 4,862,714; and 4,866,958.

To overcome the aforementioned problems associated with prior art push button padlocks, it will be seen that the combination push button and/or key operated padlock of the present invention is easy to operate, utilizes a minimum number of operating parts, is significantly less costly to manufacture, and yet affords quick, reliable and easy operation as compared to prior art padlocks. In addition, the push button padlock is a combination lock in that it also offers key operation as well.

### BRIEF SUMMARY OF THE INVENTION

Briefly stated, the push button padlock of the present invention includes a housing, a shackle detachably connected to the housing for opening and closing the padlock, a push button slide plate positioned within the housing and connected to the shackle for operative detachable movement of the shackle relative to the housing, a plurality of push buttons mounted to the housing for movement relative to the push button slide plate, and a thumb latch mounted to the housing and connected to the push button slide plate to move the push button slide plate into detachable position relative to the shackle. Some of the push buttons are constructed as releasing push buttons for pre-selected operative detachable engagement from the push button slide plate when depressed. The remainder of the push buttons are constructed as blocking push buttons for pre-selected operative engagement with the push button slide plate when depressed. The thumb latch moves the push button slide plate into detachable position relative to the shackle only when the releasing push buttons are depressed and none of the blocking push buttons are depressed. Stated differently, if any of the blocking push buttons are depressed, or not all of the releasing push buttons are depressed, then movement of the slide plate will be prevented, and the thumb latch will not be operable to move the slide plate into the detachable position relative to the shackle. Each of the push buttons has independently mounted spring loaded end caps on each free end to assist in camouflaging the releasing and blocking push buttons from each other.

The releasing push buttons comprise the pre-selected combination of push buttons used for opening the padlock.

The shackle is preferably a swivel-only J-shaped shackle mounted to the housing. Its free end is captured by a reciprocating collar that is connected to the thumb latch. The thumb latch is depressed by a user to move the reciprocating collar downwardly away from the free end of the swivel-only J-shaped shackle to open the padlock when the releasing push buttons are depressed for moving the push button slide plate into detachable position.

The push button buttons extend through opposite end walls of the housing and the spring loaded button caps on each end are independently mounted to one or the other of the opposite end walls.

Spring loaded ball bearings are mounted between the push button slide plate and housing to assure proper movement and positioning of the push buttons and push button slide plate to each other.

The releasing and blocking push buttons are arranged in a plurality of adjacently positioned rows and are resiliently mounted to the housing and to each other by elongated resilient members that extend between the releasing and blocking push buttons in the adjacently positioned rows.

### BRIEF DESCRIPTION OF THE SEVERAL VIEWS OF THE DRAWINGS

In the drawings, FIG. 1 is a front perspective view of the combination push button and/or key operated padlock in closed position;

FIG. 2 is a rear perspective thereof;

FIG. 3 is a front perspective view of the combination push button and/or key operated padlock in open position;

FIG. 4 is an exploded perspective view illustrating the components of the combination push button and/or key operated padlock;

FIG. 5 is an enlarged fragmentary inside perspective view illustrating the operative components of the combination push button and/or key operated padlock when in closed position;

FIG. 6 is an enlarged fragmentary inside perspective view similar to FIG. 5, but showing the operative components of the combination push button and/or key operated padlock in open position;

FIG. 7 is an inside elevational view of the operative components of the combination push button and/or key operated padlock in closed position;

FIG. 8 is an inside elevational view of the operative components of the combination push button and/or key operated padlock in open position;

FIG. 9 is a fragmentary sectional view of the releasing and blocking push buttons of the combination push button and/or key operated padlock when in pre-selected operative engagement with a push button slide plate;

FIG. 10 is a fragmentary sectional view of the releasing and blocking push buttons of the combination push button and/or key operated padlock when in pre-selected operative disengagement with the push button slide plate;

FIG. 11 is a fragmentary sectional view of the releasing and blocking push buttons of the combination push button and/or key operated padlock in different relative positions, but still showing pre-selected operative engagement with the push button slide plate;

FIG. 12 is an inside elevational view showing a wire which is moved by a key to allow for key operation of the padlock;

FIG. 13 is a fragmentary sectional view illustrating spring loaded ball bearings between the housing and push button slide plate operating in conjunction with the combination push button and/or key operated padlock; and

FIG. 14 is a fragmentary sectional view similar to FIG. 13 and illustrating how the key operated cylinder lock moves the push button slide plate toward the housing and, at the same time, the compress spring loaded ball bearings.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention.

While there are certain similarities of the combination push button and/or key operated padlock of the present invention to those padlocks shown in U.S. Pat. Nos. 4,781,830 and 4,862,714, it will be seen in the detailed description that follows that the combination push button and/or key operated padlock of the present invention has several important and unique features which make it far superior to the aforementioned and other padlocks of the prior art.

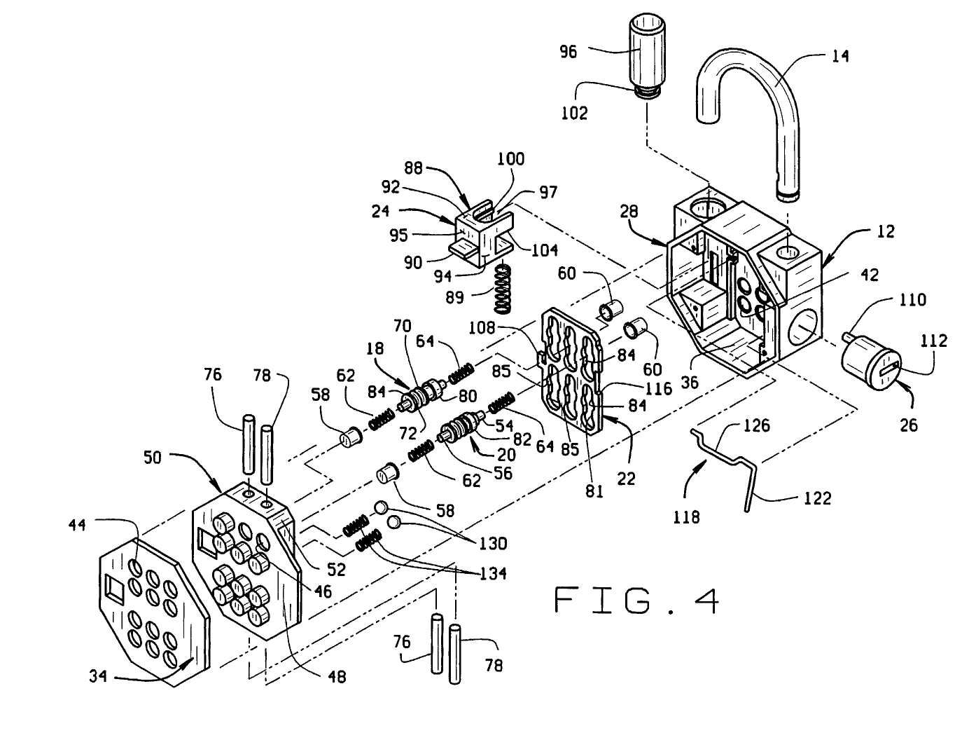

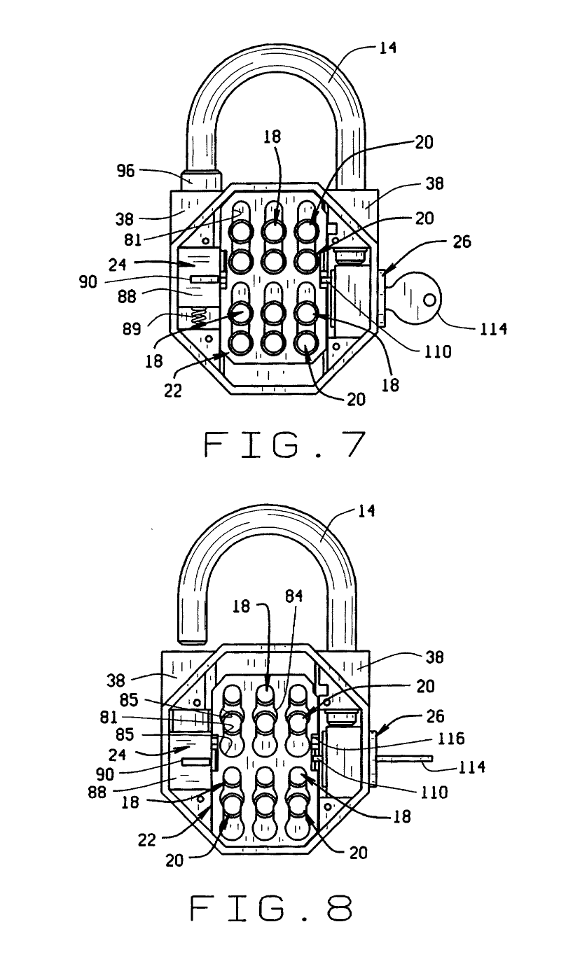

The combination push button and/or key operated padlock (“padlock”) 10 of the present invention includes a lock housing 12, an inverted J-shaped shackle 14, a plurality of push buttons 16 including releasing push buttons 18 and blocking push buttons 20 (See FIGS. 7-11) and a slide plate 22 (FIG. 4) connected to both a thumb latch assembly 24 on one side of the padlock 10 and to a key cylinder lock 26 on an opposite side of the padlock 10, both of which are designed for opening and closing the padlock 10. As will be described below, to unlock the padlock 10, all of the releasing push buttons 18 must be depressed, while none of the blocking push buttons 20 can be depressed. If not all of the releasing push buttons 18 are depressed, or if any of the blocking push buttons 20 are depressed, then the padlock 10 cannot be opened.

The lock housing 12 may be of any general shape, although as shown in the illustrated embodiment, it preferably has the unique “stop sign” shape illustrated. In this regard, the lock housing 12 includes a “stop sign” shaped body or shell 28 that incorporates a back or end wall 30 and eight interconnected side walls 32. all of which are integrally connected to the back or end wall 30. Each of the eight integrally connected side walls 32 are arranged in a “stop sign” or octagonal pattern to maintain the overall “stop sign” lock. Completing the lock housing 12 is a cover plate or end wall 34, also formed in the “stop sign” shape. The outer surface of the cover plate 34 is provided with numbers to assign a number to each of the push buttons 16. The padlock 10 shown is provided with twelve buttons in four rows of three buttons each. Hence, the first row has buttons 1-3, the second row has buttons 4-6, etc. Thus, the combination for the padlock would correspond to the location of the releasing buttons 18 in the array of buttons 16. For example, if one releasing button 18 is placed in each row of buttons, the combination for the lock could be 1-6-8-10, wherein the numbers correspond to the push button number on the face of the cover plate 34.

The J-shaped shackle 14 is mounted to the lock housing 12 through the upstanding triangular shaped bosses or supports 38 integrally attached to the lock housing 12 at the two side walls 32 immediately adjacent the upper horizontally extending side wall 32. Before discussing the operative components, it is again stressed that while the unique “stop sign” shape is the preferred design the lock housing 12 may be formed in any shape that may be desired. Also, while the J-shaped shackle 14 is preferably a swivel-only shackle, it will be understood that a reciprocating type shackle may be used in lieu of the swivel-only shackle, if desired.

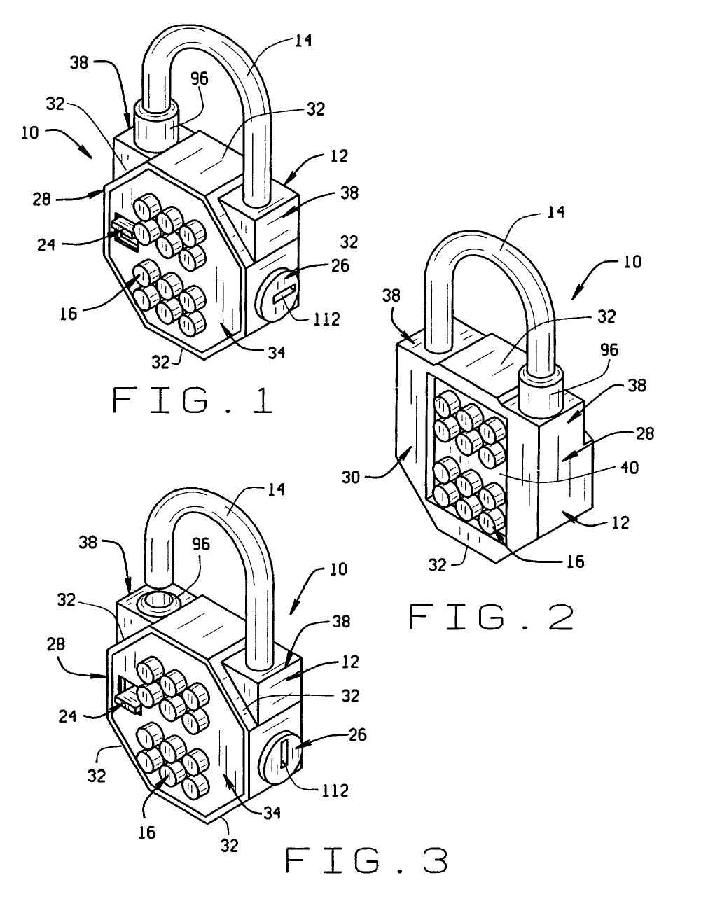

The operative components of the padlock 10 are best illustrated in the exploded perspective view of FIG. 4 of the drawings, but are also shown, at least in part, in the other Figures as well. The back or end wall 30 of the lock housing 12 has a recessed wall section 40 (FIG. 2) with a plurality of holes 42 (FIG. 4) that are aligned with a corresponding number of holes 44 in the cover plate or end wall 34 for receiving the push buttons 16. There are also a corresponding number of holes 46 in the end plate or wall 48 of the push button block 50 in which the push buttons 16 are resiliently mounted and secured, as discussed below.

The push button block 50 is located immediately below the cover plate or end wall 34 as best shown in FIG. 4. In the illustrated embodiment, there are two groups of push buttons 16, each group including three buttons arranged in two adjacent rows. This will provide a 12 push button padlock that offers a greater number of combinations than padlocks having a lesser number of push buttons. Of course, it will be understood that a greater or lesser number of push buttons 16 may be arranged in one or more rows, or could be arranged in other row patterns than the illustrated embodiment, if desired.

The operative components of the padlock 10 contained within the well or cavity 36 of the lock housing 12 include the thumb latch assembly 24, the key cylinder 26, and the push button block 50. The thumb latch assembly 24 and the key cylinder 26 are both are operatively engaged with the push button slide plate 22 to open and close the padlock 10 when the push button slide plate 22 is disengaged from the push button 16, as will be discussed below. The push buttons 16 comprise releasing push buttons 18 and blocking push buttons 20 which are mounted to the push button block 50 for axial movement relative to the push button block 50. The push button block 50 is mounted adjacent the push button slide plate 22 to enable the push buttons 16 to engage or disengage the push button slide plate 22, also discussed below. The cover plate or end wall 34, mounted adjacent the push button block 50, completes the operative components within the lock housing 12. Each of these operative components will now be discussed in further detail in the discussion that follows.

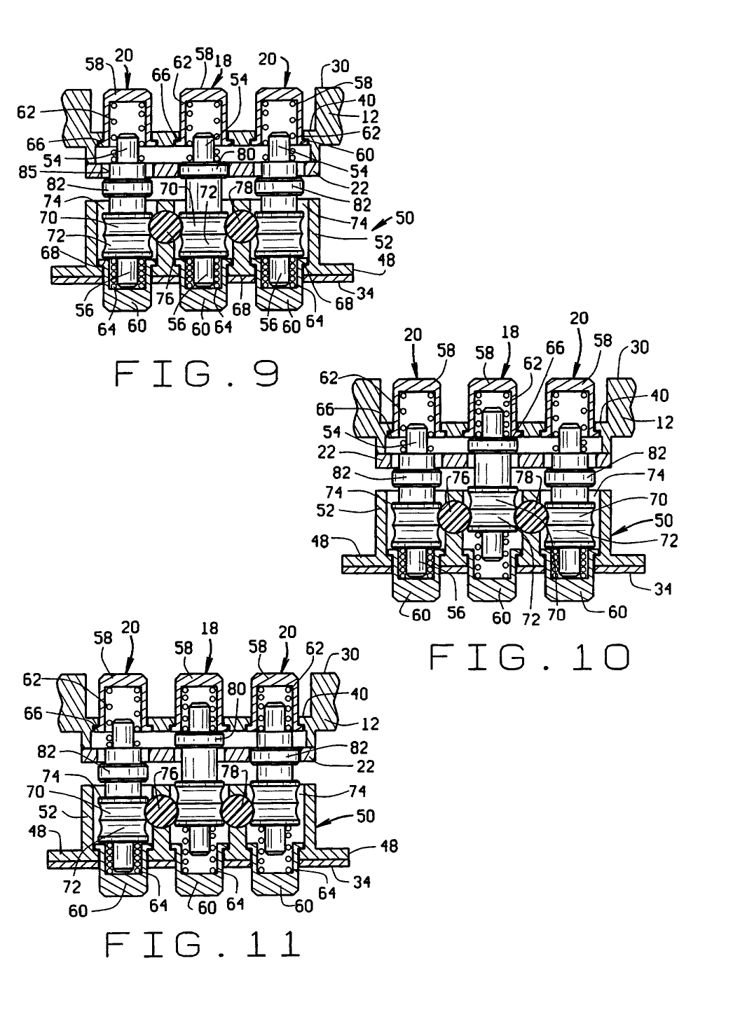

As previously described, the cover plate or end wall 34 has a plurality of openings 44 corresponding in number and location to the push buttons 18 and 20 that are mounted in the push button block 50. The push button block 50 includes an end plate or wall 48 and a button block body 52 for receiving and securing one end of the push buttons 18 and 20, as best seen in FIGS. 9-11 of the drawings. The other free end of each of the push buttons 18 and 20 is received and secured to the lock housing 12 in the recessed wall section 40.

The construction and operation of the releasing push buttons 18 and the blocking push button 20 is shown best in FIGS. 9-11 of the drawings. Both push buttons 18 and 20 have identically configured stub shaft sections 54 and 56 at opposite free ends for receiving the spring loaded button caps 58 and 60. The spring loaded button caps 58 and 60 have a hollow cylindrical construction for receiving the coil springs 62 and 64 and a outer flange 66 and 68 which sits against the area surrounding the holes 42 of the recessed wall section 40 at one end and against the area surrounding by the holes 46 of the push button block 50 at an opposite end. As a result, each of the spring loaded push button caps 58 and 60 are independently positioned against the recessed wall section 40 and the push button block 50 at opposite ends. This independent mounting feature of the push button caps assists in camouflaging the releasing push buttons 18 and blocking push buttons 20 from each other. Users will thus be unable to distinguish the operation of the releasing push buttons 18 and blocking push buttons 20 from each other.

Each of the releasing push buttons 18 and blocking push buttons 20 include an adjacent pair of semi-circular grooves 70 and 72 at the end received by the push button block 50. Note in this regard that the button block body 52 includes elongated recesses or holes 74 which receive the push buttons 16 and which are sized to comfortably receive the adjacent pair of semi-circular grooves 70 and 72 of the push buttons 18 and 20. A pair of elongated resilient members 76 and 78 extend transversely though the button block body 52 for resiliently engaging the semi-circular grooves 70 and 72 of the push buttons 18 and 20. The elongated resilient members 76 and 78 may be made of any material for resiliently engaging the semicircular grooves 68 and 70, such as a rubber or plastic material. Any other resilient flexible material will can also be used. This above described construction enables a limited amount of movement or “throw” of the push buttons 18 and 20. This feature, previously disclosed in U.S. Pat. No. 4,862,714, permits user to depress the push buttons 18 and 20 at opposite ends for limited resilient movement so as to position the push buttons 18 and 20 in engagement or disengagement relative to the push button slide plate 22. In this regard, note that the annular ring or shoulder 80 of the releasing push buttons 18 is positioned immediately adjacent the stub shaft section 54 while the annular ring or shoulder 82 of the blocking push buttons 20 is spaced axially downwardly from the stub shaft section 54. This difference construction between the releasing and blocking push buttons 18 and 20, respectively, allows for the difference in function of the two buttons. The releasing push buttons 18, when pressed, is moved from a position in which the annular ring or shoulder 80 blocks movement of the slide plate to a position in which the shoulder 80 is out of engagement with the push button slide plate 22 (FIGS. 10-11). On the other hand, when the blocking buttons are pressed, they are moved from a position in which they are out of engagement with the slide plate 22 to a position in which the shoulder 80 is engaged with the slide plate, to prevent movement of the slide plate.

The slide plate 22, as shown, includes six separate elongate slots 81, there being elongate slot 81 for each column of buttons in the top array of buttons, and another elongate slot 81 for each column of buttons in the bottom array of buttons. Each slot 81 has a width sized to allow the slide plate 22 to slide relative to push buttons 16 . The slide plate slots 81 each include two enlarged circular sections 85, one at the bottom of the slot, and one midway along the slot (with reference to FIG. 4). The circular sections have a diameter sized to receive the shoulders 80 of the push buttons 16. When the padlock 10 is locked, the enlarged sections 85 of the slide plate slots 81 are aligned with the push buttons 16.

FIG. 9 illustrates the position of the releasing push buttons 18 and blocking push buttons 20 prior to any movement. In this position, the shoulder 80 of the releasing push buttons 18 are received in the slide plate slot enlarged sections 85, and hence engage the slide plate 22 to prevent movement of the slide plate 22. The shoulders 80 of the blocking push buttons 20, on the other hand, are clear of the slide plate 22 (i.e., out of plane of the slide plate), and hence do not engage the slide plate 22 to block movement of the slide plate. As can be appreciated, despite the position of the blocking push buttons, the releasing push buttons will prevent movement of the slide plate 22 to prevent the padlock 10 from being simply opened.

FIG. 10 illustrates the disengagement position of the releasing push buttons 18 relative to the push button slide plate 22 when depressed. In this position, the shoulder 80 of the releasing push buttons 80 are out of plane with the slide plate 22, and hence is out of engagement with the slide plate 22, to allow movement of the slide plate 22. FIG. 11 illustrates blocking engagement of the blocking push buttons 20 with the push button slide plate 22 when depressed. As can be seen, the shoulder 80 of the blocking push buttons 20, are received in, or engaged with, the enlarged circular section 85 of the slide plate slot 81. Hence, the blocking push button, in this position, will prevent movement of the slide plate, even if all the releasing push buttons 18 have been moved into relative disengagement with the push button slide plate 22.

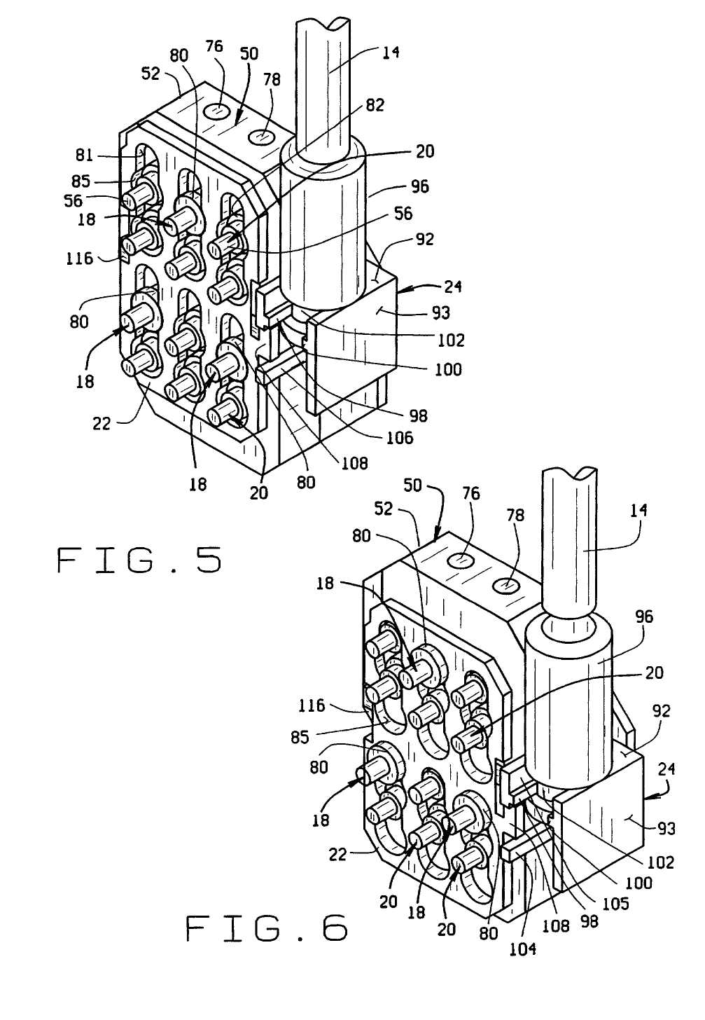

FIGS. 5 and 7 also illustrate engagement of the annular shoulder 80 of the releasing push buttons 18 with the push button slide plate 22 prior to any movement and thus corresponds to the FIG. 9 illustration. On other hand, FIGS. 6 and 8 illustrate disengagement of the annular shoulder 80 of the releasing push buttons 18 when depressed and thus corresponds to FIG. 10 of the drawings.

When all the releasing push buttons 18 are moved into disengagement position relative to the push button slide plate 22 (FIGS. 6 and 8), the push button slide plate 22 can be moved by the thumb latch assembly 24 to open the padlock 10.

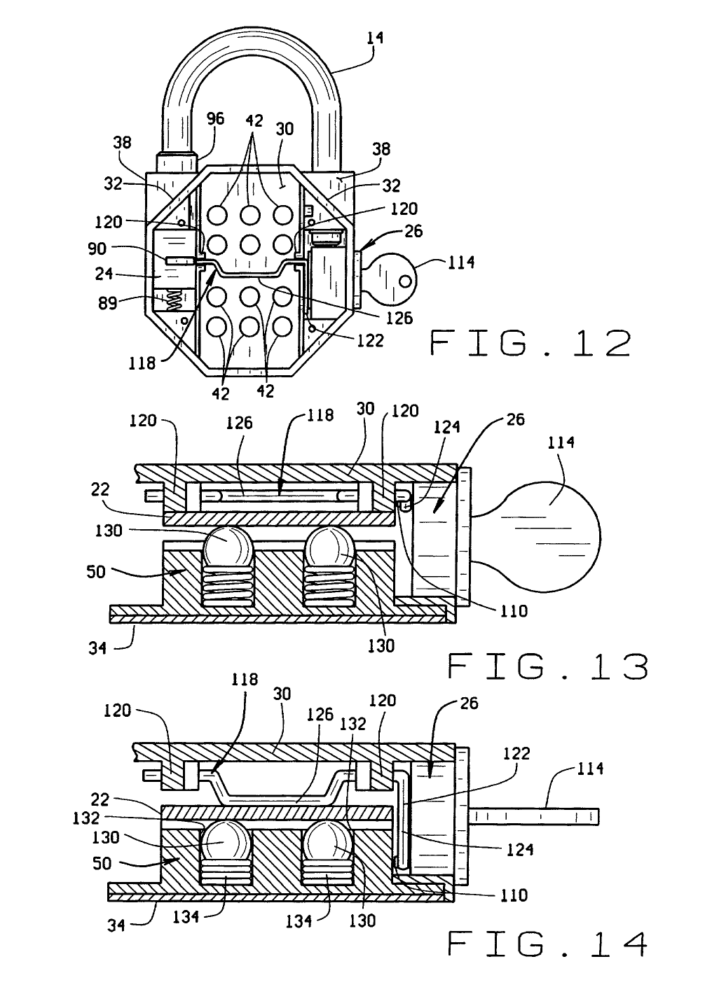

Before discussing thumb latch assembly 24, reference is made to FIG. 13 of the drawings which shows that the push button slide plate 22 is supported in its desired predetermined position by spring loaded ball bearings 86 mounted in the button block 50. This assures proper positioning and movement of the releasing push buttons 18 and blocking push buttons 20 relative to the push button slide plate 22 for smooth, continuous and reliable operation without any “hang-ups.”

The thumb latch assembly 24 (FIGS. 4-6) includes a hollow cage-like structure 88 with a thumb latch 90 extending from one side for depression by a user to move the push button slide plate 22 from the engaged position shown in FIGS. 5 and 7 to the disengaged position shown in FIGS. 6 and 8. The hollow cage-like structure includes a top 92, a first side 93, a second side 94 opposite the first side 93, and a front 95. The thumb latch 90 extends from the front 95. A generally U-shaped opening 97 is formed in the top surface 92 and is sized to receive the hollow cylindrically-shaped shackle sleeve 96. A spaced pair of internal shoulders or ribs 98 and 100 are formed on the inner surfaces of the sides 93 and 94. The shackle sleeve 96 includes a cylindrical groove 102 for receiving the spaced pair of internal shoulders 98 and 100 at its lower end while the upper end of the cylindrical groove 102 extends above spaced legs 92 and 94. In this way, the cage-like structure 88 is connected to the shackle sleeve 96 to permit downward movement of the shackle sleeve 96 when the thumb latch 90 is moved downwardly by a user. The cage-like structure is resiliently supported by a spring 89 that urges the cage-like structure upwardly until the thumb latch 90 is depressed by a user.

For connection to the push button slide plate 22, the cage-like structure 88 includes an slot or cutout 104 in the second side 94 of the cage like structure 88. The push button slide plate 22 includes a locking tab 108 which is received in the cutout 104. Thus, depression of the thumb latch 90 not only moves the push button slide plate 22 into disengaged position relative to the releasing push buttons 18, at the same time, it moves the shackle sleeve 96 downwardly out of engagement with the free end of the shackle 14, as shown in FIGS. 6 and 8. As can be appreciated, the thumb latch 90, and hence the shackle sleeve 96, can only be moved when all the releasing push buttons 18 are pressed and none of the blocking push buttons 20 are pressed. The shackle sleeve 96 is supported within the upstanding triangular shaped boss 38 on one side of the padlock 10 adjacent the thumb latch assembly 24. This assures non-binding movement of the shackle sleeve 96 relative to the free end of the shackle 14. The opposite end of the shackle 14 is pivotally mounted to the padlock 10 in the upstanding triangular-shaped boss 38 on the opposite side of the padlock 10, thus enabling the shackle 14 to be swiveled away from the padlock 10 when the shackle sleeve 96 is moved downwardly, as shown in FIGS. 3, 6 and 8 and as described above.

Another way of opening the padlock 10 is through the key cylinder lock 26. As best seen in FIGS. 4 and 12-14, the key cylinder lock 26 includes an unlocking tab 110 that extends from the key cylinder lock 26 on an end opposite the key slot 112. The padlock 10 also includes a wire 118 that is mounted in the body 12 between the back wall 30 and the slide plate 22. The wire form 118 is mounted to back end or end wall 30 of the housing 12 through the spaced journal supports 120 of the back end or end wall 30. The wire form 118 includes a rotating arm 122 which is engaged the tab extension 110 on the key cylinder lock 26, and a lifting arm 126 which engages the push button slide plate 22 when the wire 118 is rotated. As can be seen, the lifting arm defines a bend. such that, as the wire 118 is rotated in the journal supports 120, the lifting arm 126 will rise out of the plane of the back or end wall 30. Thus, as the key 114 is rotated from the locked position shown in FIG. 13 to the unlocked position shown in FIG. 14, the rotating arm 122 is engaged by the tab extension 110 of the key cylinder lock 26 to cause the lifting arm 126 of the wire form 118 to engage and lift or push the push button slide plate 22 against the spring loaded ball bearings 130. The ball bearings 130 are received in holes 132 in the button lock body 52. Springs 134 bias the ball bearings 130 outwardly against the slide plate 22. Prior to rotating the key, all the buttons 16 (all the releasing push buttons 18 and all the blocking push buttons 20) must be depressed. When the all the push buttons 16 are depressed and the key 14 is rotated to lift the slide plate 22, the slide plate 22 is lifted to a position to be disengaged from the shoulders 80 of all the push buttons 16. Thus, with the slide plate out of engagement of the push buttons, the thumb latch can be pulled down to pull down the shackle sleeve 96 to unlock the padlock 10.

From the above, it will now be appreciated that the combination push button and/or key operated padlock 10 can be quickly, easily and accurately operated using either the push buttons 18 or the key 114, while also assuring positive locking and unlocking of the padlock 10. Further, the blocking push buttons 20 make it more difficult for someone to “pick” the lock.

As various changes could be made in the above constructions without departing from the scope of the invention, it is intended that all matter contained in the above description or shown in the accompanying drawings shall be interpreted as illustrative and not in a limiting sense. For example, as noted above, the shape of the padlock and the number of push buttons can be altered. These examples are merely illustrative.

I claims

1. A push button padlock comprising:
a housing,
a shackle mounted to said housing and movable between an open position in which said padlock in unlocked and a closed position in which said padlock is locked,
a shackle detachment movable between a first position in which said shackle detachment engages an end of said shackle to prevent said shackle from moving from its closed position to its open position and a second position in which said shackle detachment is disengaged from said shackle to allow said shackle to move between said open and closed positions;
a push button slide plate for operatively connected to said shackle detachment;
a plurality of push buttons mounted to said housing for said push button slide plate, said push buttons being movable between a raised position and a pressed position; at least one of said push buttons being constructed as releasing push button, the remainder of said push buttons being constructed as blocking push buttons;
said at least one releasing push button engaging said slide plate when said at least one releasing push button is in said raised position to prevent movement of said slide plate and hence prevent movement of said shackle detachment from said first position to said second position and being disengaged from said slide plate when in said pressed position to allow movement of said slide plate, and hence to permit movement of said shackle detachment from said first position to said second position;
said blocking push buttons being out of engagement said slide plate when said blocking push button is in said raised position to permit movement of said slide plate and hence permit movement of said shackle detachment from said first position to said second position and being engaged with said slide plate when in said pressed position to prevent movement of said slide plate, and hence to prevent movement of said shackle detachment from said first position to said second position;
whereby, said shackle detachment can be moved from said first position to said second position only when said at least one releasing push button is in said pressed position and all said blocking push buttons are in said raised position.
said push buttons having independently mounted spring caps to assist in camouflaging the at least one releasing push button and the blocking push buttons from each other;

2. The padlock as defined in claim 1 in which said push buttons are arranged in a desired pattern on a face of said padlock; said releasing push buttons being selectively placed within said pattern of push buttons to comprise a pre-selected combination of push buttons used for opening said padlock.

3. The padlock as defined in claim 1 in which the push buttons extend through opposite end walls of the housing and the spring loaded button caps on each end are independently mounted to one or the other of said opposite end walls.

4. The padlock as defined in claim 1 in which the shackle is constructed as a swivel-only shackle relative to said housing.

5. The padlock as defined in claim 4 in which the shackle detachment includes a reciprocating sleeve which engages said shackle and a thumb latch which extends from said housing, said swivel-only shackle being opened by movement of said thumb latch after only said at least one releasing button has been moved to said pressed position.

6. The padlock as defined in claim 1 in which spring loaded ball bearings extend between the push button slide plate and the housing to assure smooth, continuous and reliable operation of said padlock.

7. The padlock as defined in claim 1 in which said push buttons include at least two adjacent rows of three push buttons each, and an elongated resilient member extending transverse to said two adjacent rows of push buttons between each adjacent pair of push buttons in each row to resiliently retain said push buttons while enabling pre-selected movement of push buttons for operative engagement and disengagement relative to said push button slide plate.

8. The padlock as defined in claim 7 including two groups of at least two adjacent rows of three push buttons each, each of said groups having an elongated resilient member extending transverse to said two adjacent rows of push buttons between each adjacent pair of push buttons in each row.

9. The padlock as defined in claim 8, in which there are common elongated resilient members between said two groups including at least two adjacent rows of three push buttons each.

10. The padlock as defined in claim 1 including a key lock is both mounted to said housing and operatively connected to said push button slide plate to disengage said slide plate from said both said releasing and blocking push buttons to permit movement of said slide plate for opening and closing said padlock.

11. The padlock as defined in claim 10 including a wire pivotably mounted in said housing between said slide plate and an end wall of said slide plate; said wire being pivoted by operation of said key lock; said wire including a lifting arm which presses against said slide plate to disengage said slide plate from said push buttons.

12. A push button locking assembly including a housing, a shackle detachably connected to said housing, a push button slide plate operatively movable relative to said shackle for detachable connection of said shackle relative to said housing, and a plurality of push buttons for pre-selected engagement and disengagement relative to said push button slide plate, at least one of said push buttons being constructed for pre-selected operative disengagement of said push button slide plate relative to said shackle for detachable connection of said shackle from said housing, the remainder of said push buttons being constructed for pre-selected operative engagement relative to said push button slide plate to prevent movement of said push button slide plate relative to said shackle as well as prevent detachable connection of said shackle relative to said housing, and a shackle detachment connected to both said push button slide plate and shackle for disconnecting the push button slide plate from the shackle when only those push buttons constructed for pre-selected operative disengagement from said push button slide plate are engaged, and each of said push buttons having independently mounted spring loaded end caps on each free end to assist in camouflaging the operation of push buttons from each other.

13. A push button locking assembly including a swivel-only shackle detachably mounted to a housing, a push button slide plate operatively movable relative to said shackle for a detachable connection of said swivel-only shackle relative to said housing, a plurality of push buttons for pre-selected engagement or disengagement of said push button slide plate, all of said push buttons being constructed for operative movement relative to said push button slide plate, at least one of said push buttons also being constructed for pre-selected operative disengagement of said push button slide plate relative to said shackle for detachable connection of said shackle from said housing, and the remainder of said push buttons being constructed for pre-selected operative engagement of said push button slide plate with said shackle to prevent detachable connection of said shackle relative to said housing, said swivelonly shackle being released from said housing by a thumb latch that is both mounted to said housing and operatively connected to the push button slide plate for releasing said swivel-only shackle when the thumb latch is depressed and the push buttons constructed for pre-selected operative disengagement from said push button slide plate are engaged, and each of said push buttons having independently mounted spring loaded end caps on each free end to assist in camouflaging the operation of push buttons from each other.

14. A push button padlock comprising a housing, a shackle detachably connected to said housing for opening and closing said padlock, a push button slide plate positioned within the housing and connected to the shackle for operative detachable movement of said shackle relative to the housing, a plurality of push buttons mounted to said housing for movement relative to the push button slide plate, and a thumb latch mounted to said housing and connected to the push button slide plate for moving the push button slide plate into detachable position relative to the shackle, some of said push buttons being constructed as releasing push buttons for pre-selected operative detachable engagement from the push button slide plate when depressed, the remainder of said push buttons being constructed as blocking push buttons for pre-selected operative engagement with said push button slide plate when depressed, said thumb latch moving said push button slide plate into detachable position relative to said shackle only when said releasing push buttons are depressed and none of said blocking push buttons are depressed and each of said push buttons having independently mounted spring loaded end caps on each free end to assist in camouflaging the releasing and blocking push buttons from each other.

15. The push button padlock as defined in claim 14 in which the releasing push buttons comprise the pre-selected combination of push buttons used for opening said padlock.

16. The push button padlock as defined in claim 15 in which the shackle is a swivel-only J-shaped shackle mounted to said housing, the swivel-only J-shaped shackle having its free end captured by a reciprocating collar that is connected to the thumb latch, said thumb latch capable of being depressed by a user to move the reciprocating collar downwardly away from the free end of the swivel-only J-shaped shackle for opening the padlock when the releasing push buttons only are depressed for moving the push button slide plate into detachable position.

17. The push button padlock as defined in claim 16 in which the push buttons extend through opposite end walls of the housing and the spring loaded button caps are independently mounted to one or the other of said opposite end walls.

18. The push button padlock as defined in claim 17 in which spring loaded ball bearings are mounted between the push button slide plate and housing to assure proper movement and positioning of the push buttons and push button slide plate to each other.

19. The push button padlock as defined in claim 18 in which the releasing and blocking push buttons are arranged in a plurality of adjacently positioned rows and resiliently mounted to said housing and to each other by elongated resilient members that extend between the releasing and blocking push buttons in said adjacently positioned rows.

20. The push button padlock as defined in claim 14 including a key operated cylinder rotatably mounted in said housing and a wire pivotally mounted in said housing; said key operated cylinder including a finger on an end wall thereof; said wire including a pivot arm engagable by said finger of said key operated cylinder and a lifting arm engagable with said slide plate; said finger of said key operated cylinder engaging said wire pivot arm when said cylinder is rotated to rotate said wire; said wire lift arm engaging said slide plate when rotated to disengage said slide plate from both said at least one releasing push button and said blocking push buttons to allow movement of said slide plate.
